(19) United States
(12) Patent Application Publication
(10) Pub. No.: US 2025/0258706 A1
(43) Pub. Date: Aug. 14, 2025

(54) MATTER COMPUTE ARCHITECTURE WITH SMART DISCOVERY AND OPPORTUNISTIC ALLOCATION OF IOT DEVICE RESOURCES

(71) Applicant: GM Global Technology Operations LLC, Detroit, MI (US)

(72) Inventors: Venkata Naga Siva Vikas Vemuri, Farmington Hills, MI (US); Lakshmi V. Thanayankizil, Troy, MI (US); John Sergakis, Bloomfield Hills, MI (US); Andrew J. MacDonald, Grosse Pointe Park, MI (US)

(73) Assignee: GM Global Technology Operations LLC, Detroit, MI (US)

(21) Appl. No.: 18/437,371

(22) Filed: Feb. 9, 2024

(51) Int. Cl. G06F 9/50

(52) U.S. Cl. CPC G06F 9/5027

(57) ABSTRACT

A method for a Matter compute architecture with smart discovery and opportunistic allocation of IoT device resources includes obtaining a device identifier for each of a plurality of devices within an ecosystem of a vehicle, each device identifier including resource capabilities and resource needs of the device. For each device, the method also includes validating the device based on the obtained device identifier, and classifying the device based on the resource capabilities and the resource needs of the device. The method also includes generating a device controller matrix by identifying an ecosystem resource requirement for the plurality of devices, predicting an ecosystem resource availability for the plurality of devices, and prioritizing the resource capabilities and the resource needs of each device based on the ecosystem resource requirement and the ecosystem resource availability.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a matter compute architecture with smart discovery and opportunist allocation of internet of things (IoT) device resources. By virtue of its inherent mobility, a modern vehicle is in dynamic communication with IoT devices that enter and exit an ecosystem of the vehicle depending on a location of the vehicle relative to the IoT devices. While these IoT devices may opt into the ecosystem of the vehicle, not all of these IoT devices may use the same communication link (i.e., communication fabric) to communicate with the vehicle. As such, IoT devices may not be able to see or communicate with IoT devices in different fabrics.

### SUMMARY

One aspect of the disclosure provides a computer-implemented method for a matter compute architecture with smart discovery and opportunistic allocation of IoT device resources that when executed on data processing hardware causes the data processing hardware to perform operations that include obtaining a device identifier for each of a plurality of devices within an ecosystem of a vehicle. Each device identifier includes respective resource capabilities and respective resource needs of the device. For each device of the plurality of devices, the operations also include validating the device based on the obtained device identifier, and classifying the device based on the respective resource capabilities and the respective resource needs of the device. The operations also include generating a device controller matrix by identifying, based on the respective resource needs of each device of the plurality of devices, an ecosystem resource requirement for the plurality of devices in the ecosystem of the vehicle, predicting, based on the device classifications for the plurality of devices, an ecosystem resource availability for the plurality of devices in the ecosystem of the vehicle, and prioritizing the respective resource capabilities and the respective resource needs of each device of the plurality of devices based on the ecosystem resource requirement and the ecosystem resource availability.

Implementations of the disclosure may include one or more of the following optional features. In some implementations, classifying each device of the plurality of devices based on the respective resource capabilities and the respective resource needs of the device further includes assigning a role to each device of the plurality of devices. In these implementations, the assigned role of each device of the plurality of devices may include one of a donor device, a recipient device, or a hybrid device. Here, generating the device controller matrix may further include reassigning a hybrid device as one of a donor device or a recipient device based on the ecosystem resource requirement and the ecosystem resource availability.

In some examples, classifying each device of the plurality of devices based on the respective resource capabilities and the respective resource needs of the device includes assigning a role to the device. Here, prioritizing the respective resource capabilities and the respective resource needs of each device of the plurality of devices includes identifying a first device of the plurality of devices having respective resource capabilities that exceed respective resource needs. In these examples, generating the device controller matrix may further include updating the device classification of the first device by reassigning the role of the first device to a donor device role, assigning the respective resource capabilities of the first device that exceed the respective resource needs of the first device to a second device having a recipient device role.

In some implementations, classifying each device of the plurality of devices based on the respective resource capabilities and the respective resource needs of the device includes assigning a role to the device. Here, prioritizing the respective resource capabilities and the respective resource needs of each device of the plurality of devices includes identifying a first device of the plurality of devices having respective resource needs that exceed respective resource capabilities. In these examples, generating the device controller matrix may further include updating the device classification of the first device by reassigning the role of the first device to a recipient device role, and assigning the respective resource capabilities of a second device having a donor device role to the first device.

In some implementations, generating the device controller matrix is further based on a device presence pattern. In some examples, a first device of the plurality of devices includes a first communication protocol, and a second device of the plurality of devices includes a second communication protocol. Here, the first device and the second device are in communication through the ecosystem of the vehicle.

Another aspect of the disclosure provides a system for a matter compute architecture with smart discovery and opportunistic allocation of IoT device resources that includes data processing hardware and memory hardware in communication with the data processing hardware. The memory hardware stores instructions that when executed by the data processing hardware cause the data processing hardware to perform operations that include obtaining a device identifier for each of a plurality of devices within an ecosystem of a vehicle. Each device identifier includes respective resource capabilities and respective resource needs of the device. For each device of the plurality of devices, the operations also include validating the device based on the obtained device identifier, and classifying the device based on the respective resource capabilities and the respective resource needs of the device. The operations also include generating a device controller matrix by identifying, based on the respective resource needs of each device of the plurality of devices, an ecosystem resource requirement for the plurality of devices in the ecosystem of the vehicle, predicting, based on the device classifications for the plurality of devices, an ecosystem resource availability for the plurality of devices in the ecosystem of the vehicle, and prioritizing the respective resource capabilities and the respective resource needs of each device of the plurality of devices based on the ecosystem resource requirement and the ecosystem resource availability.

This aspect may include one or more of the following optional features. In some implementations, classifying each device of the plurality of devices based on the respective resource capabilities and the respective resource needs of the device further includes assigning a role to each device of the plurality of devices. In these implementations, the assigned role of each device of the plurality of devices may include one of a donor device, a recipient device, or a hybrid device. Here, generating the device controller matrix may further include reassigning a hybrid device as one of a donor device or a recipient device based on the ecosystem resource requirement and the ecosystem resource availability.

In some examples, classifying each device of the plurality of devices based on the respective resource capabilities and the respective resource needs of the device includes assigning a role to the device. Here, prioritizing the respective resource capabilities and the respective resource needs of each device of the plurality of devices includes identifying a first device of the plurality of devices having respective resource capabilities that exceed respective resource needs. In these examples, generating the device controller matrix may further include updating the device classification of the first device by reassigning the role of the first device to a donor device role, assigning the respective resource capabilities of the first device that exceed the respective resource needs of the first device to a second device having a recipient device role.

In some implementations, classifying each device of the plurality of devices based on the respective resource capabilities and the respective resource needs of the device includes assigning a role to the device. Here, prioritizing the respective resource capabilities and the respective resource needs of each device of the plurality of devices includes identifying a first device of the plurality of devices having respective resource needs that exceed respective resource capabilities. In these examples, generating the device controller matrix may further include updating the device classification of the first device by reassigning the role of the first device to a recipient device role, and assigning the respective resource capabilities of a second device having a donor device role to the first device.

In some implementations, generating the device controller matrix is further based on a device presence pattern. In some examples, a first device of the plurality of devices includes a first communication protocol, and a second device of the plurality of devices includes a second communication protocol. Here, the first device and the second device are in communication through the ecosystem of the vehicle.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The drawings described herein are for illustrative purposes only of selected configurations and are not intended to limit the scope of the present disclosure.

FIG. 1 is a schematic view of an example system for a matter compute architecture with smart discovery and opportunistic allocation.

FIG. 2 is a schematic view of example components of the system of FIG. 1.

FIG. 3 is a schematic view of an example recipient device in communication with an example recipient device through a device controller system of a vehicle.

FIG. 4 is a flowchart of an example arrangement of operations for a method of a matter compute architecture with smart discovery and opportunistic allocation.

FIG. 5 is a flowchart of an example arrangement of operations for a method of a matter compute architecture with smart discovery and opportunistic allocation.

FIG. 6 is a flowchart of an example arrangement of operations for a method of classifying a device in a matter compute architecture.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

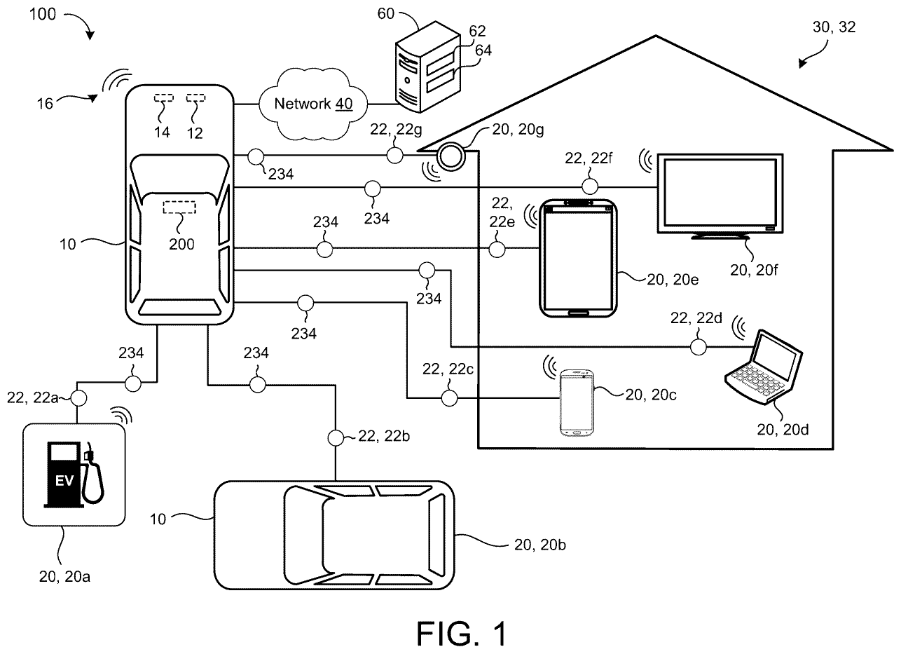

FIG. 1 illustrates an example system 100 including a device controller system 200 executing a service donor allocation model 230. The device controller system 200 includes a vehicle 10 in communication with a plurality of internet of things (IoT) devices 20, 20a-n (also referred to as devices 20) within an ecosystem 30 of the vehicle 10 via a vehicle network 16. The ecosystem 30 may include any devices 20 within an environment 32 (i.e., a network range 32) of the vehicle network 16. The vehicle network 16 may include a wireless local area network (WLAN) that facilitates communication and interoperability among the vehicle 10 and the devices 20 within the environment 32 of the vehicle 10. In the example shown, the devices 20 within the environment 30 have all opted into the ecosystem 30 of the vehicle 10, and, as such, are in communication with the vehicle 10 via the device controller system 200. In particular, the devices 20 are located around the vehicle 10 and include an electric vehicle (EV) charging station 20a, a guest vehicle 20b, a cellular device 20c, a personal computer 20d, a tablet 20e, a television (TV) 20f, and a camera system 20g. The device controller system 200 may communicate with each of the devices 20 in the ecosystem 30 via wireless or wired communications technologies and/or protocols. Thus, the vehicle network 16 can include Wireless Fidelity (WiFi®) (e.g., IEEE 802.11), Low-Rate Wireless Personal Area Networks (e.g., IEEE 802.15.4), worldwide interoperability for microwave access (WiMAX), 3G, 4G, Long Term Evolution (LTE), 5G, digital subscriber line (DSL), Bluetooth®, Near Field Communication (NFC), or any other wireless standards, or Ethernet (e.g., IEEE 802.3). The vehicle 10 may additionally include one or more access points (AP) (not shown) configured to facilitate wireless communication between the vehicle 10 and one or more of the devices 20, 20a-g.

Additionally, each device 20 may communicate with other devices 20 within the same communication fabric/cluster as the device 20. For example, the devices 20c-20g in FIG. 1 are shown as part of a premises of a user, where the devices 20c-20g may be in communication with one another via a first communication fabric (e.g., a home area network (HAN)), while the devices 20a, 20b, may not be a part of the first communication fabric, and instead may communicate with the vehicle 10 via a second communication fabric that is different from the first communication fabric. Consequently, the devices 20b-20g can only communicate with the devices 20a, 20b via the vehicle 10 (i.e., executing the device controller system 200).

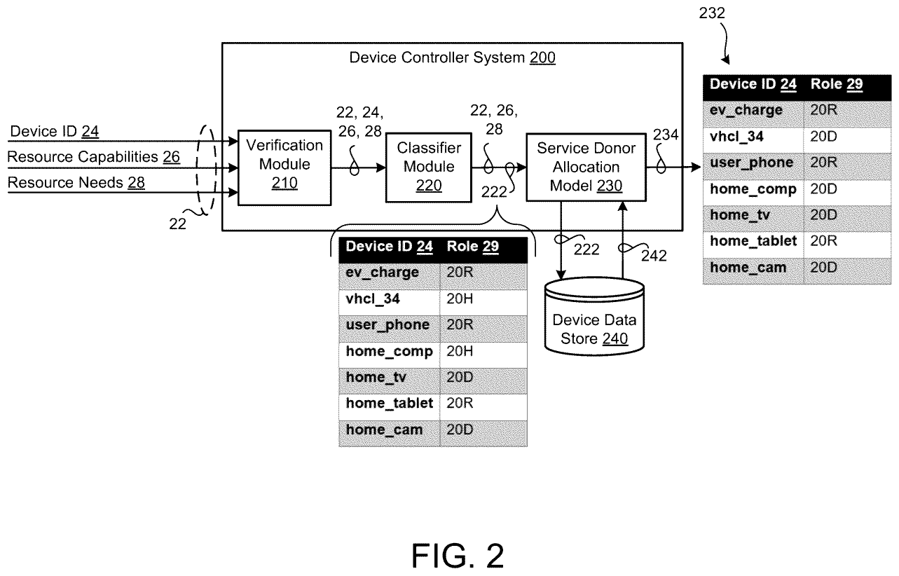

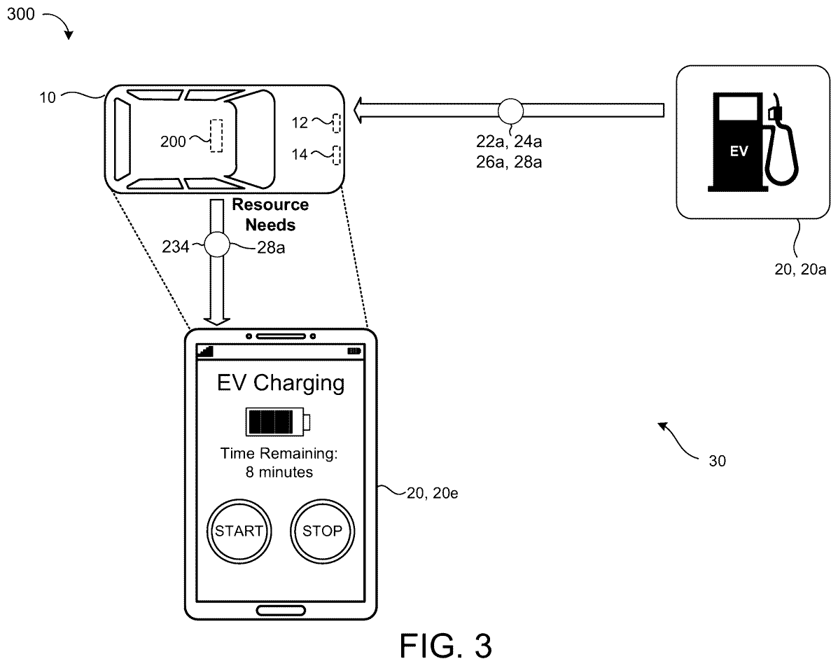

In the examples shown, the device controller system 200 is implemented within the vehicle 10. However, the device controller system 200 can be implemented on other computing devices (e.g., computing devices in communication with the vehicle 10), such as, without limitation, a smart phone, tablet, smart display, desktop/laptop, smart watch, smart appliance, or smart glasses/headset. The vehicle 10 includes data processing hardware 12 and memory hardware 14 storing instructions that when executed on the data processing hardware 12 cause the data processing hardware 14 to perform operations. In addition to the vehicle network 16, the vehicle 10 is in communication with a remote system 60 via a network 40. The remote system 60 (e.g., server, cloud computing environment) also includes data processing hardware 62 and memory hardware 64 storing instructions that when executed on the data processing hardware 62 cause the data processing hardware 62 to perform operations. In some examples, execution of the device controller system 200 is shared across the vehicle 10 and the remote system 60. As described in greater detail below with reference to FIGS. 2 and 3, the device controller system 200 executing on the vehicle 10 and/or the remote system 60 executes a verification module 210, a classifier module 220, and a service donor allocation model 230, and is configured to intelligently discover devices 20 that dynamically join and leave the vehicle network 16, where the device controller system 200 opportunistically allocates resources 26, 28 of the devices 20 based on predictions of near-future resource availability to reduce cost and increase efficiency, thereby improving utilization of the devices 20. Notably, because the device controller system 200 of the vehicle 10 is communication agnostic (i.e., it communicates via a common application programming interface (API)), it operates to integrate/facilitate communication between devices 20 that are otherwise unaware of devices 20 outside of their own communication fabrics.

The device controller system 200 can be implemented on any computing device that is capable of communication with the devices 20. While the device controller system 200 is included within the vehicle 10 in the example shown, the device controller system 200 may also be included in, without limitation, a smart phone, a smart watch, a laptop, a desktop, or a smart display. When a device 20 opts into the ecosystem 30 (e.g., by a user of the device 20 during a communication association process with the vehicle 10), it may thereafter be discoverable by the device controller system 200 of the vehicle 10 any time that the device 20 is within range (e.g., the environment 32) of the vehicle 10.

In some implementations, the vehicle 10 executes the device controller system 200 (including the service donor allocation model 230) that initiates communication with each device 20 such that each device 20 (i.e., a device 20 with a role 29 of a donor device 29D) of the plurality of devices 20 is controllable by the device controller system 200 to perform available actions (i.e., via the resource capabilities 26) requested by a different device 20 (i.e., a device 20 with the role 29 of a recipient device 29R). In the example shown, the device controller system 200 obtains the device identifier 22 for each of the plurality of devices 20 within the ecosystem 30 of the vehicle 10. In some implementations, the vehicle 10 intelligently discovers the device 20 when it enters the ecosystem 30 of the vehicle 10 and generates a request for the device identifier 22 that prompts the device 20 to share its device identifier 22. In other implementations, when a device 20 enters the ecosystem 30, the device 20 may advertise its intent to join the ecosystem 30, thereby prompting the vehicle 10 to request the device identifier 22 of the device 20.

Each device identifier 22 may include a respective device identity (ID) 24 including a unique identifier of the device 20, respective resource capabilities 26 of the device 20, and respective resource needs 28 of the device 20. The device identifier 22 may include a fabric certificate communicating the device ID 24, respective resource capabilities 26, and respective resource needs 28 of the device 20, where the device controller system 200 (via a common API) understands/translates the fabric certificate to integrate the device 20 with the other devices 20 within the ecosystem 30. The resource capabilities 26 include the intrinsic resource capabilities of the device 20, such as, the energy capability/capacity of the device 20, the available storage of the device 20, the computing cost of the device 20, the processing performance (e.g., MIPS) of the device 20, any communication fabrics of the device 20, an estimation of the amount of time the device 20 will be underutilized (e.g., how long the device 20 will have available resource capabilities 26), an estimation of the amount of time the device 10 will be in the ecosystem 30 of the vehicle 10, as well as standard services such as displays, cameras, and sensors operated by the device 20. The resource needs 28 may include the dynamic usage of the device 20 (e.g., its baseline operations), as well as any capability needs that the device 20 may have that exceed the resource capabilities 26 of the device 20. For example, a device 20 that does not include a graphical user interface may have a resource need 28 for a graphical user interface when to display information to a user of the device 20.

With reference to FIGS. 1 and 2. the device controller system 200 includes the verification module 210. the classifier module 220. the service donor allocation model 230. and a device data store 240. The verification module 210 is configured to receive the obtained device identifier 22 and. based on the device identifier 22 (e.g., the device ID 24), validate the device 20. For example, the vehicle 10 may validate the device 20 by checking the device ID 24 against a list of known devices 20 that have opted into the ecosystem 30 of the device controller system 200. If the verification module 210 determines that the device 20 is not a valid device. it may block the device 20 from the ecosystem 30 of the vehicle 10.

If the verification module 210 validates the device 20, the classification module 220) is configured to classify the device 20 based on the device ID 24, the resource capabilities 24. and the resource needs 28 of the device 20, and output device classifications 222 for the plurality of devices 20. For example. the classification module 220 may assign a role 29 to each device 20 of the plurality of devices 20. The roles 29 assigned by the classification module include a donor device 20D. a recipient device 20R. and a hybrid device 20H. The donor devices 20D may be devices 20 that include resource capabilities 26 that exceed the resource needs 28 of the donor device 20D. Conversely. the recipient devices 20R may be devices 20 that include resource needs 28 that exceed the resource capabilities 26 of the recipient device 20R. Put another way, donor devices 20D may be devices 20 that are currently underutilized. while recipient devices 20R may be devices 20 that currently lack the resource capabilities 26 necessary to optimally operate. Notably. a device role 29 may be assigned based on a particular service performed by the device 20. For example, when the device 20 is a smart thermostat. it can serve as a donor device 20D for weather application information. but cannot serve as a donor device 20D for imaging. Instead. if the smart thermostat needed imaging services. it may be assigned the role 29 of a recipient device 20R for imaging services. The hybrid devices 20H may be devices 20 that may either serve as a donor device 20D or a recipient device 20R depending on the optimal utilization of the capabilities 26 and needs 28 in the ecosystem 30 at any given moment.

With continued reference to FIG. 2. after the classifier module 220 outputs the device classifications 222 for the plurality of devices 20. the service donor allocation model 230 may receive the device classifications 222 including each device identifier 22 having the respective resource capabilities 26 and the respective resource needs 28. and generate a device controller matrix 232. In particular, the service donor allocation model 230 predicts, based on the respective resource needs 28 of each device 20 of the plurality of devices 20. an ecosystem resource need 224 for the plurality of devices 20 in the ecosystem 30 of the vehicle 10. Here, the service donor allocation model 230 predicts the ecosystem resource need 224 based on the existing resource needs 28 of the devices 20.

The service donor allocation model 230 further predicts, based on the device classifications 222 and the respective resource capabilities 26 of each device 20, an ecosystem resource availability 226 for the plurality of devices 20 in the ecosystem 30 of the vehicle 10. The ecosystem resource availability 226 indicates an estimation of a near-future (e.g., one second, five seconds, five minutes, etc.,) resource availability of the devices 20 within the ecosystem 30 of the vehicle 10 and is based on the dynamic usage of each device 20 communicated in the device identifier 22, as well as historical data 242 of the behavior of the devices 20. For example, the service donor allocation model 230 accesses a device data store 240) that records/stores historical data 242 that includes historically received device identifiers 22 including device IDs 24, resource capabilities 26, and resource needs 28, device classifications 222, and ecosystem resource needs 224 and ecosystem resource availabilities 226 for previous states of the ecosystem 30. Additionally, previous device controller matrixes 232 may be stored in the device data store 240. The historical records of the device data store 240 may be stored on the memory hardware 14 of the vehicle 10 and/or the memory hardware 64 of the remote server 60. Here, when predicting the ecosystem resource availability 226 for the plurality of devices 20, the service donor allocation model 230 may estimate, based on the historical data 242 stored in the device data store 240, an average amount of time that a device 20 is within the ecosystem 30, how often the device 20 is within the ecosystem 30, a device presence pattern indicating how often and how long the device 20 is within the ecosystem 30, and/or patterns in the respective capabilities 26 of the device 20 while in the ecosystem 30. For example, the device data store 240) may include historical data indicating a presence pattern of the guest vehicle 20b that the guest vehicle 20b enters the ecosystem 30 for four (4) hours every week day (i.e., Monday-Friday). In this example, the ecosystem resource availability 226 predicted by the service donor allocation model 230 may include the respective capabilities 26b of the guest vehicle 20b as a predicted available resource for other devices 20 in the ecosystem 30 of the vehicle 10. The service donor allocation model 230 may give priority to the respective capabilities 26b of the guest vehicle 20b based on a confidence level of the presence pattern of the guest vehicle 20b.

With the ecosystem resource needs 224 and the ecosystem resource availabilities 226, the service donor allocation model 230 then prioritizes the respective resource capabilities 26 and the respective resource needs 28 of each device 20 of the plurality of devices 20 to generate the device controller matrix 232. In some implementations, the service donor allocation model 230 only updates the device controller matrix 232 from a previous time step when the ecosystem resource needs 224 meets or exceeds a minimum threshold (e.g., the ecosystem resource capabilities 226, or 90% of the ecosystem resource capabilities 226) of resource usage in the ecosystem 30 of the vehicle 10. Put another way, when the ecosystem resource needs 224 are less than the ecosystem resource availability 226, the service donor allocator model 230 may maintain a current device controller matrix 232 and continue to monitor the ecosystem resource needs 224 until the ecosystem resource needs are equal to or exceed the minimum threshold Additionally, the service donor allocation model 230 may generate one or more resource assignments 234 for each of the devices 20 that are assigned to offer resources (i.e., are donor devices 20D), and communicate the resource assignments 234 to the respective devices 20 within the environment. In prioritizing the respective resource capabilities 26 and the respective resource needs 28, the service donor allocation model 230) may optimize the mix of device roles 29 based on the dynamically changing needs (i.e., as devices 20 join and leave) of the ecosystem 30 of the vehicle 10. For example, the service donor allocation model 230 may reassign the role 29 of a hybrid device 20H to one of the role of a donor device 20D and the role of a recipient device 20R based on one of the ecosystem resource needs 224 and the ecosystem resource availabilities 226. As shown in FIG. 2, while the device classifications 222 initially included the device ID 24 of vhcl_34 (e.g., guest vehicle 20b) and the device ID 24 of home_comp as assigned to the role of a hybrid device 20H, the service donor allocation model 230 re-assigns the roles 29 when generating the device controller matrix 232 to the role 29 of a donor device 20D.

In some implementations, after the classifier module 220 has assigned a role 29 to each device 20, the service donor allocation model 230 may modify/update the assigned role 29 when it prioritizes the respective resource capabilities 26 and the respective resource needs 28 of each device 20 of the plurality of devices 20. For example, when prioritizing the respective resource capabilities 26 and the respective resource needs 28 of each device 20, the service donor allocation model 230 may identify a first device 20 of the plurality of devices 20 that has respective resource capabilities 26 that exceed the respective resource needs 24 of the device 20. For example, the first device 20 may be the guest vehicle 20b that is parked and not in use, and, as such, is not currently using its own resource capabilities 26. Here, when generating the device controller matrix 232, the service donor allocation model 230 updates the device classification 222 of the guest vehicle 20b by reassigning the role 29 of the guest vehicle 20b to the role 29 of a donor device 20D. Thereafter, the service donor allocation model 230 may send resource assignments 234 to the guest vehicle 20b to perform using its underutilized resource capabilities 26.

Conversely, when prioritizing the respective resource capabilities 26 and the respective resource needs 28 of each device 20, the service donor allocation model 230 may identify a second device 20 of the plurality of devices 20 that has respective resource needs 28 that exceed the respective resource capabilities 26 of the second device 20. For example, the second device 20 may be the camera system 20g mounted to an exterior surface of the residence of FIG. 1, but, by virtue of its location, cannot capture image data outside of its field-of-view. However, in situations where the camera system 20g needs additional fields-of-view (i.e., for security of the residence), it may benefit from any imaging devices within the ecosystem 30. Here, when generating the device controller matrix 232, the service donor allocation model 230 updates the device classification 222 of the camera system 20g by reassigning the role 29 of the camera system 20g to the role 29 of a recipient device 20R. Thereafter, the service donor allocation model 230 may send resource assignments 234 to a device 20 (e.g., the guest vehicle 20b having imaging resources) assigned a donor role 20D within the ecosystem 30 that is capable of fulfilling the resource needs 28g of the camera system 20g.

With reference to FIG. 3, a system 300 including the vehicle 10 is shown with the EV charger 20a and the tablet 20e within the ecosystem 30 of the vehicle 10. Here, the tablet 20e is disposed within the vehicle 10, and the EV charger 20a does not have a screen for displaying information. When the device controller system 200 obtains the device identifier 22 of the EV charger 20a (e.g., when the EV charger 20a enters the range of the vehicle network 16), the device controller system 200 may classify the EV charger 20a under the role of a recipient device 20R for the capabilities of displaying data. Put differently, because the EV charger 20a does not include a screen, the device controller system 200 may identify and validate the EV charger 20a as a device that may benefit from available resource capabilities 26 for displaying data from an available device 20 within the ecosystem 30 of the vehicle 10 that includes a screen. Here, when the service donor allocation model 230 generates the device controller matrix 232 it may identify that the tablet 20e is not currently using its respective capability 26 of displaying data. In other words, the displaying data capability 26 of the tablet 20e is currently underutilized within the ecosystem 30. The vehicle 10 may then assign the tablet 20e to display the data from the EV charger 20a so that a passenger of the vehicle 10 may be apprised of the charging status of the vehicle.

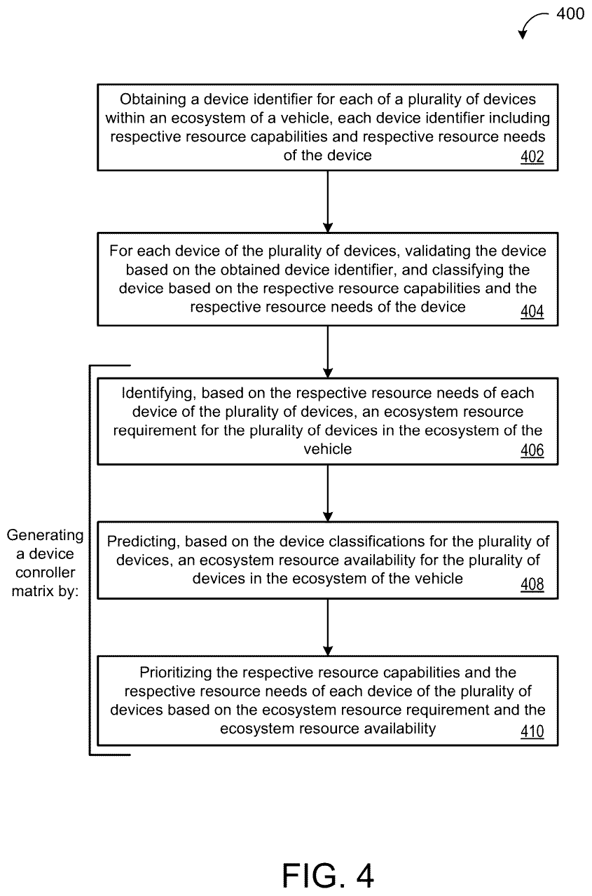

FIG. 4 includes a flowchart of an example arrangement of operations for a method 400 for a matter compute architecture with smart discovery and opportunistic allocation of IoT device resources. Data processing hardware (e.g., data processing hardware 12, 62 of FIG. 1) may execute instructions stored on memory hardware (e.g., memory hardware 14, 64 of FIG. 1) to perform the example arrangement of operations for the method 400. At operation 402, the method 400 includes obtaining a device identifier 22 for each of a plurality of devices 20 within an ecosystem 30 of a vehicle 10. Each device identifier 22 includes respective resource capabilities 26 and respective resource needs 28 of the device 20.

For each device 20 of the plurality of devices 20, the method 400 also includes, at operation 404, validating the device 20 based on the obtained device identifier 22, and classifying the device 20 based on the respective resource capabilities 26 and the respective resource needs 28 of the device 20. At operation 406, the method 400 also includes generating a device controller matrix 232 by identifying, based on the respective resource needs 28 of each device 20 of the plurality of devices 20, an ecosystem resource requirement 224 of the plurality of devices 20 in the ecosystem 30 of the vehicle 10. The method 400 further includes, at operation 408, predicting, based on the device classifications 222 for the plurality of devices 20, an ecosystem resource availability 226 for the plurality of devices 20 in the ecosystem 30 of the vehicle 10. The method 400 also includes, at operation 410, prioritizing the respective resource capabilities 26 and the respective resource needs 28 of each device 20 of the plurality of the plurality of devices 20 based on the ecosystem resource requirement 224 and the ecosystem resource availability 226.

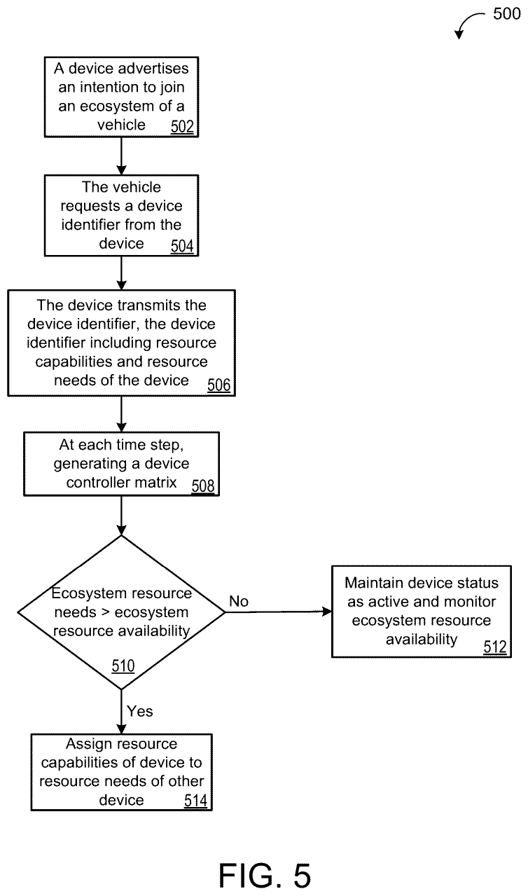

FIG. 5 includes a flowchart of an example arrangement of operations for a method 500 for the device controller 200 to intelligently discover devices 20 within an ecosystem 30 of a vehicle and opportunistically allocate unused or underutilized capabilities 26 of the devices 20. Data processing hardware (e.g., data processing hardware 12, 62 of FIG. 1) may execute instructions stored on memory hardware (e.g., memory hardware 14, 64 of FIG. 1) to perform the example arrangement of operations for the method 500. At operation 502, the method 500 includes a device 20 advertising an intention to join an ecosystem 30 of a vehicle 10. The device 20 may advertise its intention by opting into the ecosystem 30 of the vehicle 10. For example, when the device 20 is within communication range (e.g., within a range of a vehicle network 16) of the vehicle 10, it may prompt a user of the device 20 to opt into the ecosystem 30 of the vehicle 10. In other examples, the device 20 may automatically advertise its intention to join the ecosystem 30 when it is within communication range of the vehicle 10.

At operation 504, the method 500 also includes the vehicle 10 (e.g., via the device controller system 200), requesting a device identifier 22 from the device 20. For example, the device identifier 22 may include a communication certificate. At operation 506, the operations 500 also include the device 20 transmitting the device identifier 22. Here, the device identifier 22 includes resource capabilities 26 (e.g., the computing capacity) and resource needs 28 (e.g., computational needs) of the device 20. The device identifier 22 may further include a device ID 24 of the device 20. At each time step, the method 500 also includes, at operation 508, generating a device controller matrix 232. Here, at operation 510, a service donor allocation model 230 of the device controller system 200 determines whether the identified ecosystem resource needs 224 exceed the predicted near-future ecosystem resources 226. Put another way, the service donor allocation model 230 determines whether the identified ecosystem resource needs 224 are less than a minimum threshold of resource usage of the ecosystem 30 such that no further optimization is necessary. If the ecosystem resource needs 224 do not exceed the predicted near-future ecosystem resources 226, the method 500 proceeds to operation 512, where the service donor allocation model 230 maintains the device 20 in the device controller matrix 232 with an active status, and continues to monitor the ecosystem resource availability 224. If the ecosystem resource needs 224 do exceed the predicted near-future ecosystem resources 226, the method 500 proceeds from the operation 510 to the operation 514, where the service donor allocation model 230 assigns, in the device controller matrix 232, the resource capabilities 26 of the device 20 to the resource needs 28 of another device 20 that is also in the ecosystem 30 of the vehicle 10.

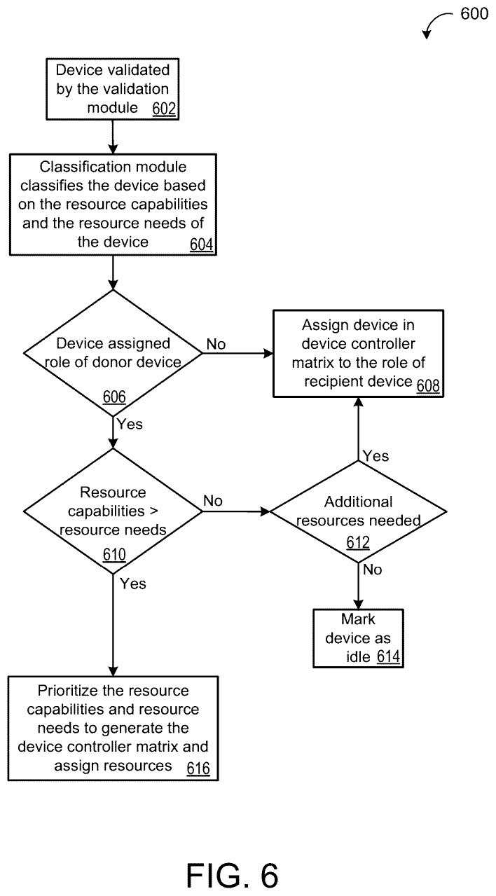

FIG. 6 includes a flowchart of an example arrangement of operations for a method 600 for of classifying a device 20 in a matter compute architecture by updating a device classification 222 in a device controller matrix 232. Data processing hardware (e.g., data processing hardware 12, 62 of FIG. 1) may execute instructions stored on memory hardware (e.g., memory hardware 14, 64 of FIG. 1) to perform the example arrangement of operations for the method 600. At operation 602, the method 600 includes validating the device 20 using a validation module 210. At operation 604, the method 600 also includes classifying, using a classification module 220, the device 20 based on the resource capabilities 26 and the resource needs 28 of the device 20.

At operation 606, the method 600 includes determining whether the device 20 is assigned a role 29 of a donor device 20D. If the device 20 not assigned the role 29 of the donor device 20D, the method 600 proceeds to operation 608 of assigning the device 20 in the device controller matrix 232 to the role 29 of a recipient device 20R. If the device 20 is assigned the role 29 of the donor device 20D, the method 600 proceeds to operation 610, which includes determining whether the resource capabilities 26 of the device 20 exceed the resource needs 28 of the device 20. If, at operation 610, the resource capabilities 26 of the device 20 do not exceed (i.e., are equal to or less than) the resource needs 28 of the device 20, the method 600 proceeds to operation 612, which determines whether the device 20 needs additional resource capabilities 26. If the device 20 needs additional resource capabilities 26, the method 600 returns to operation 608, and assigns (i.e., reassigns) the device 20 in the device controller matrix 232 to the role 29 of a recipient device 20R.

At operation 612. if the device 20 does not need additional resource capabilities 26, the method 600 proceeds to operation 614, where the service donor allocation model 230 may update the device controller matrix 232 to include an idle status. If, at operation 610, the resource capabilities 26 of the device 20 exceed the resource needs 28 of the device 20 (i.e., the device 20 includes unused or underutilized resource capabilities 26), the method 600 proceeds to operation 616, which includes prioritizing the resource capabilities 26 and the resource needs 28 of the device 20 to generate the device controller matrix 232, and generating one or more resource assignments 234 that assign the respective resource needs 28 of another device 20 to the resource capabilities 28 of the device 20.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method when executed on data processing hardware causes the data processing hardware to perform operations comprising:
obtaining a device identifier for each of a plurality of devices within an ecosystem of a vehicle, each device identifier including respective resource capabilities and respective resource needs of the device;
for each device of the plurality of devices:
validating the device based on the obtained device identifier; and
classifying the device based on the respective resource capabilities and the respective resource needs of the device; and
generating a device controller matrix by:
identifying, based on the respective resource needs of each device of the plurality of devices, an ecosystem resource requirement for the plurality of devices in the ecosystem of the vehicle;
predicting, based on the device classifications for the plurality of devices, an ecosystem resource availability for the plurality of devices in the ecosystem of the vehicle; and
prioritizing the respective resource capabilities and the respective resource needs of each device of the plurality of devices based on the ecosystem resource requirement and the ecosystem resource availability.

2. The method of claim 1, wherein classifying each device of the plurality of devices based on the respective resource capabilities and the respective resource needs of the device further comprises assigning a role to each device of the plurality of devices.

3. The method of claim 2, wherein the assigned role of each device of the plurality of devices includes one of a donor device, a recipient device, or a hybrid device.

4. The method of claim 3, wherein generating the device controller matrix further includes reassigning a hybrid device as one of a donor device or a recipient device based on the ecosystem resource requirement and the ecosystem resource availability.

5. The method of claim 1, wherein classifying each device of the plurality of devices based on the respective resource capabilities and the respective resource needs of the device includes assigning a role to the device; and
wherein prioritizing the respective resource capabilities and the respective resource needs of each device of the plurality of devices comprises identifying a first device of the plurality of devices having respective resource capabilities that exceed respective resource needs.

6. The method of claim 5, wherein generating the device controller matrix further comprises:
updating the device classification of the first device by reassigning the role of the first device to a donor device role; and
assigning the respective resource capabilities of the first device that exceed the respective resource needs of the first device to a second device having a recipient device role.

7. The method of claim 1, wherein classifying each device of the plurality of devices based on the respective resource capabilities and the respective resource needs of the device includes assigning a role to the device; and
wherein prioritizing the respective resource capabilities and the respective resource needs of each device of the plurality of devices comprises identifying a first device of the plurality of devices having respective resource needs that exceed respective resource capabilities.

8. The method of claim 7, wherein generating the device controller matrix further comprises:
updating the device classification of the first device by reassigning the role of the first device to a recipient device role; and
assigning the respective resource capabilities of a second device having a donor device role to the first device.

9. The method of claim 1, wherein the generating the device controller matrix is further based on a device presence pattern.

10. The method of claim 1, wherein a first device of the plurality of devices includes a first communication protocol, and a second device of the plurality of devices includes a second communication protocol, the first device and the second device in communication through the ecosystem of the vehicle.

11. A system comprising:
data processing hardware; and
memory hardware in communication with the data processing hardware, the memory hardware storing instructions that when executed on the data processing hardware cause the data processing hardware to perform operations comprising:
obtaining a device identifier for each of a plurality of devices within an ecosystem of a vehicle, each device identifier including respective resource capabilities and respective resource needs of the device;
for each device of the plurality of devices:
validating the device based on the obtained device identifier; and
classifying the device based on the respective resource capabilities and the respective resource needs of the device; and
generating a device controller matrix by:
identifying, based on the respective resource needs of each device of the plurality of devices, an ecosystem resource requirement for the plurality of devices in the ecosystem of the vehicle;
predicting, based on the device classifications for the plurality of devices, an ecosystem resource availability for the plurality of devices in the ecosystem of the vehicle; and
prioritizing the respective resource capabilities and the respective resource needs of each device of the plurality of devices based on the ecosystem resource requirement and the ecosystem resource availability.

12. The system of claim 11, wherein classifying each device of the plurality of devices based on the respective resource capabilities and the respective resource needs of the device further comprises assigning a role to each device of the plurality of devices.

13. The system of claim 12, wherein the assigned role of each device of the plurality of devices includes one of a donor device, a recipient device, or a hybrid device.

14. The system of claim 13, wherein generating the device controller matrix further includes reassigning a hybrid device as one of a donor device or a recipient device based on the ecosystem resource requirement and the ecosystem resource availability.

15. The system of claim 11, wherein classifying each device of the plurality of devices based on the respective resource capabilities and the respective resource needs of the device includes assigning a role to the device; and
wherein prioritizing the respective resource capabilities and the respective resource needs of each device of the plurality of devices comprises identifying a first device of the plurality of devices having respective resource capabilities that exceed respective resource needs.

16. The system of claim 15, wherein generating the device controller matrix further comprises:
updating the device classification of the first device by reassigning the role of the first device to a donor device role; and
assigning the respective resource capabilities of the first device that exceed the respective resource needs of the first device to a second device having a recipient device role.

17. The system of claim 11, wherein classifying each device of the plurality of devices based on the respective resource capabilities and the respective resource needs of the device includes assigning a role to the device; and
wherein prioritizing the respective resource capabilities and the respective resource needs of each device of the plurality of devices comprises identifying a first device of the plurality of devices having respective resource needs that exceed respective resource capabilities.

18. The system of claim 17, wherein generating the device controller matrix further comprises:
updating the device classification of the first device by reassigning the role of the first device to a recipient device role; and
assigning the respective resource capabilities of a second device having a donor device role to the first device.

19. The system of claim 11, wherein the generating the device controller matrix is further based on a device presence pattern.

20. The system of claim 11, wherein a first device of the plurality of devices includes a first communication protocol, and a second device of the plurality of devices includes a second communication protocol, the first device and the second device in communication through the ecosystem of the vehicle.
